(19) United States
(12) Patent Application Publication
(10) Pub. No.: US 2016/0066089 A1
(43) Pub. Date: Mar. 3, 2016

(54) SYSTEM AND METHOD FOR ADAPTIVE INTELLIGENT NOISE SUPPRESSION

(71) Applicant: Audience, Inc., Mountain View, CA (US)

(72) Inventor: David Klein, Los Altos, CA (US)

(21) Appl. No.: 14/495,550

(22) Filed: Sep. 24, 2014

Related U.S. Application Data
(63) Continuation of application No. 13/426,436, filed on Mar. 21, 2012, now Pat. No. 8,886,525.
Application No. 13/426,436 is a continuation of application No. 11/825,563, filed on Jul. 6, 2007, now Pat. No. 8,744,844.

(51) Int. Cl. H04R 3/00

(52) U.S. Cl. CPC H04R 3/002; H04R 2430/00; H04R 2410/05

(57) ABSTRACT

Systems and methods for adaptive intelligent noise suppression are provided. In exemplary embodiments, a speech distortion estimate is determined based on a primary acoustic signal which represents at least one captured sound. The speech distortion estimate is used to derive control signals which adjust an enhancement filter. The enhancement filter is used to generate a plurality of gain masks, which may be applied to the primary acoustic signal to generate a noise suppressed signal.

### CROSS-REFERENCE TO RELATED APPLICATIONS

The present application is a continuation of U.S. patent application Ser. No. 13/426,436, filed Mar. 21, 2012 and entitled “System and Method for Adaptive Intelligent Noise Suppression,” which, in turn, is a continuation of U.S. patent application Ser. No. 11/825,563, filed Jul. 6, 2007 and entitled “System and Method for Adaptive Intelligent Noise Suppression,” now U.S. Pat. No. 8,744,844, issued Jun. 3, 2014, both of which are herein incorporated by reference. The present application is related to U.S. patent application Ser. No. 11/343,524, filed Jan. 30, 2006 and entitled “System and Method for Utilizing Inter-Microphone Level Differences for Speech Enhancement,” now U.S. Pat. No. 8,345,890, issued Jan. 1, 2013, and U.S. patent application Ser. No. 11/699,732, filed Jan. 29, 2007 and entitled “System And Method For Utilizing Omni-Directional Microphones For Speech Enhancement,” now U.S. Pat. No. 8,194,880, issued Jun. 5, 2012, both of which are herein incorporated by reference.

### BACKGROUND OF THE INVENTION

1. Field of Invention

The present invention relates generally to audio processing and more particularly to adaptive noise suppression of an audio signal.

2. Description of Related Art

Currently, there are many methods for reducing background noise in an adverse audio environment. One such method is to use a constant noise suppression system. The constant noise suppression system will always provide an output noise that is a fixed amount lower than the input noise. Typically, the fixed noise suppression is in the range of 12-13 decibels (dB). The noise suppression is fixed to this conservative level in order to avoid producing speech distortion, which will be apparent with higher noise suppression.

In order to provide higher noise suppression, dynamic noise suppression systems based on signal-to-noise ratios (SNR) have been utilized. This SNR may then be used to determine a suppression value. Unfortunately, SNR, by itself, is not a very good predictor of speech distortion due to existence of different noise types in the audio environment. SNR is a ratio of how much louder speech is than noise. However, speech may be a non-stationary signal which may constantly change and contain pauses. Typically, speech energy, over a period of time, will comprise a word, a pause, a word, a pause, and so forth. Additionally, stationary and dynamic noises may be present in the audio environment. The SNR averages all of these stationary and non-stationary speech and noise. There is no consideration as to the statistics of the noise signal; only what the overall level of noise is.

In some prior art systems, an enhancement filter may be derived based on an estimate of a noise spectrum. One common enhancement filter is the Wiener filter. Disadvantageously, the enhancement filter is typically configured to minimize certain mathematical error quantities, without taking into account a user's perception. As a result, a certain amount of speech degradation is introduced as a side effect of the noise suppression. This speech degradation will become more severe as the noise level rises and more noise suppression is applied. That is, as the SNR gets lower, lower gain is applied resulting in more noise suppression. This introduces more speech loss distortion and speech degradation.

Therefore, it is desirable to be able to provide adaptive noise suppression that will minimize or eliminate speech loss distortion and degradation.

### SUMMARY OF THE INVENTION

Embodiments of the present invention overcome or substantially alleviate prior problems associated with noise suppression and speech enhancement. In exemplary embodiments, a primary acoustic signal is received by an acoustic sensor. The primary acoustic signal is then separated into frequency bands for analysis. Subsequently, an energy module computes energy/power estimates during an interval of time for each frequency band (i.e., power estimates). A power spectrum (i.e., power estimates for all frequency bands of the acoustic signal) may be used by a noise estimate module to determine a noise estimate for each frequency band and an overall noise spectrum for the acoustic signal.

An adaptive intelligent suppression generator uses the noise spectrum and a power spectrum of the primary acoustic signal to estimate speech loss distortion (SLD). The SLD estimate is used to derive control signals which adaptively adjust an enhancement filter. The enhancement filter is utilized to generate a plurality of gains or gain masks, which may be applied to the primary acoustic signal to generate a noise suppressed signal.

In accordance with some embodiments, two acoustic sensors may be utilized: one sensor to capture the primary acoustic signal and a second sensor to capture a secondary acoustic signal. The two acoustic signals may then be used to derive an inter-level difference (ILD). The ILD allows for more accurate determination of the estimated SLD.

In some embodiments, a comfort noise generator may generate comfort noise to apply to the noise suppressed signal. The comfort noise may be set to a level that is just above audibility.

### BRIEF DESCRIPTION OF THE DRAWINGS

FIG. 1 is an environment in which embodiments of the present invention may be practiced.

FIG. 2 is a block diagram of an exemplary audio device implementing embodiments of the present invention.

FIG. 3 is a block diagram of an exemplary audio processing engine.

FIG. 4 is a block diagram of an exemplary adaptive intelligent suppression generator.

FIG. 5 is a diagram illustrating adaptive intelligent noise suppression compared to constant noise suppression systems.

FIG. 6 is a flowchart of an exemplary method for noise suppression using an adaptive intelligent suppression system.

FIG. 7 is a flowchart of an exemplary method for performing noise suppression.

FIG. 8 is a flowchart of an exemplary method for calculating gain masks.

### DESCRIPTION OF EXEMPLARY EMBODIMENTS

The present invention provides exemplary systems and methods for adaptive intelligent suppression of noise in an audio signal. Embodiments attempt to balance noise suppression with minimal or no speech degradation (i.e., speech loss distortion). In exemplary embodiments, power estimates of speech and noise are determined in order to predict an amount of speech loss distortion (SLD). A control signal is derived from this SLD estimate, which is then used to adaptively modify an enhancement filter to minimize or prevent SLD. As a result, a large amount of noise suppression may be applied when possible, and the noise suppression may be reduced when conditions do not allow for the large amount of noise suppression (e.g., high SLD). Additionally, exemplary embodiments adaptively apply only enough noise suppression to render the noise inaudible when the noise level is low. In some cases, this may result in no noise suppression.

Embodiments of the present invention may be practiced on any audio device that is configured to receive sound such as, but not limited to, cellular phones, phone handsets, headsets, and conferencing systems. Advantageously, exemplary embodiments are configured to provide improved noise suppression while minimizing speech degradation. While some embodiments of the present invention will be described in reference to operation on a cellular phone, the present invention may be practiced on any audio device.

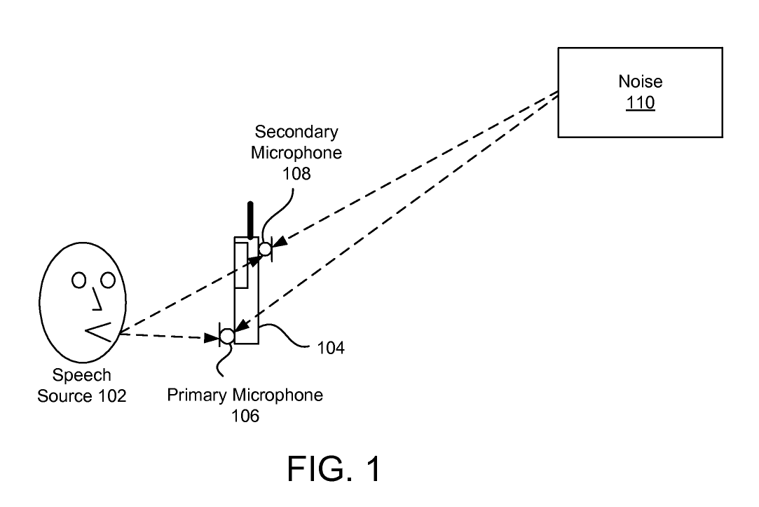

Referring to FIG. 1, an environment in which embodiments of the present invention may be practiced is shown. A user acts as a speech source 102 to an audio device 104. The exemplary audio device 104 comprises two microphones: a primary microphone 106 relative to the speech source 102 and a secondary microphone 108 located a distance away from the primary microphone 106. In some embodiments, the microphones 106 and 108 comprise omni-directional microphones.

While the microphones 106 and 108 receive sound (i.e., acoustic signals) from the speech source 102, the microphones 106 and 108 also pick up noise 110. Although the noise 110 is shown coming from a single location in FIG. 1, the noise 110 may comprise any sounds from one or more locations different than the speech source 102, and may include reverberations and echoes. The noise 110 may be stationary, non-stationary, and/or a combination of both stationary and non-stationary noise.

Some embodiments of the present invention utilize level differences (e.g., energy differences) between the acoustic signals received by the two microphones 106 and 108. Because the primary microphone 106 is much closer to the speech source 102 than the secondary microphone 108, the intensity level is higher for the primary microphone 106 resulting in a larger energy level during a speech/voice segment, for example.

The level difference may then be used to discriminate speech and noise in the time-frequency domain. Further embodiments may use a combination of energy level differences and time delays to discriminate speech. Based on binaural cue decoding, speech signal extraction or speech enhancement may be performed.

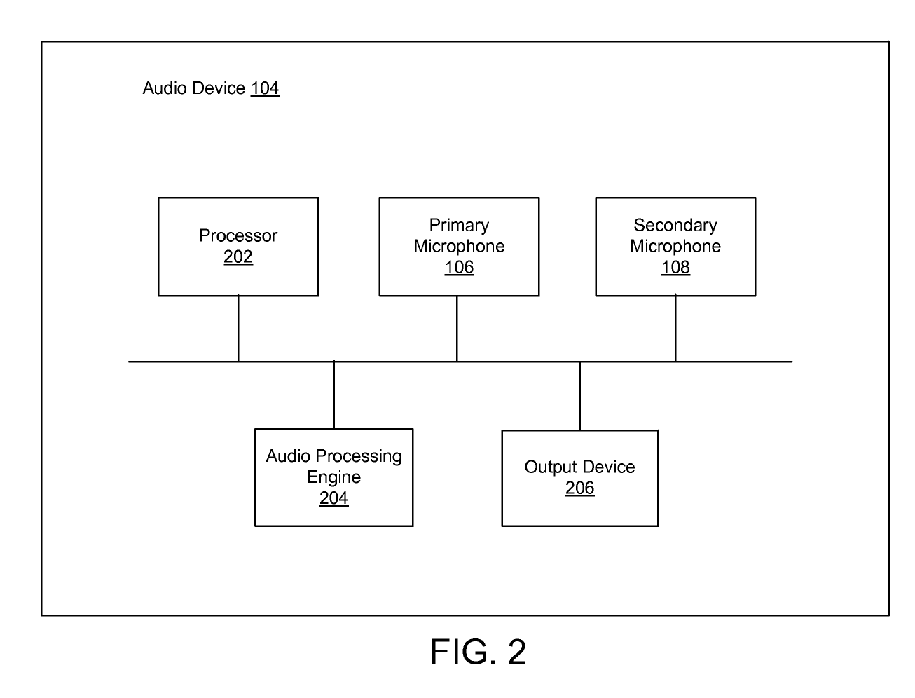

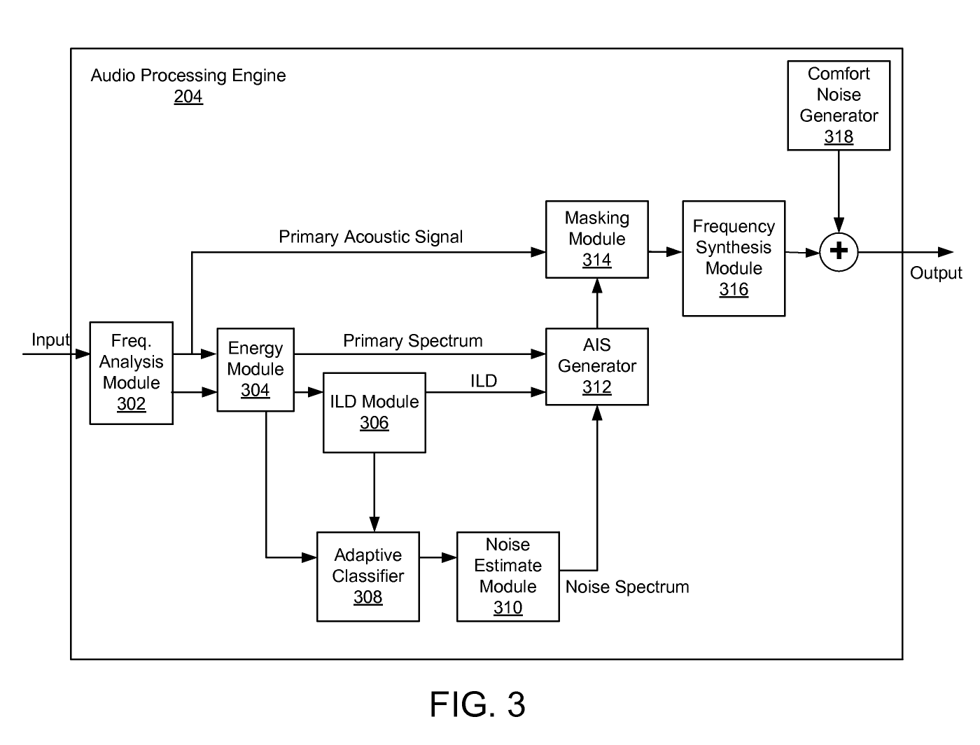

Referring now to FIG. 2, the exemplary audio device 104 is shown in more detail. In exemplary embodiments, the audio device 104 is an audio receiving device that comprises a processor 202, the primary microphone 106, the secondary microphone 108, an audio processing engine 204, and an output device 206. The audio device 104 may comprise further components necessary for audio device 104 operations. The audio processing engine 204 will be discussed in more details in connection with FIG. 3.

As previously discussed, the primary and secondary microphones 106 and 108, respectively, are spaced a distance apart in order to allow for an energy level differences between them. Upon reception by the microphones 106 and 108, the acoustic signals are converted into electric signals (i.e., a primary electric signal and a secondary electric signal). The electric signals may themselves be converted by an analog-to-digital converter (not shown) into digital signals for processing in accordance with some embodiments. In order to differentiate the acoustic signals, the acoustic signal received by the primary microphone 106 is herein referred to as the primary acoustic signal, while the acoustic signal received by the secondary microphone 108 is herein referred to as the secondary acoustic signal. It should be noted that embodiments of the present invention may be practiced utilizing only a single microphone (i.e., the primary microphone 106).

The output device 206 is any device which provides an audio output to the user. For example, the output device 206 may comprise an earpiece of a headset or handset, or a speaker on a conferencing device.

FIG. 3 is a detailed block diagram of the exemplary audio processing engine 204, according to one embodiment of the present invention. In exemplary embodiments, the audio processing engine 204 is embodied within a memory device. In operation, the acoustic signals received from the primary and secondary microphones 106 and 108 are converted to electric signals and processed through a frequency analysis module 302. In one embodiment, the frequency analysis module 302 takes the acoustic signals and mimics the frequency analysis of the cochlea (i.e., cochlear domain) simulated by a filter bank. In one example, the frequency analysis module 302 separates the acoustic signals into frequency bands. Alternatively, other filters such as short-time Fourier transform (STFT), sub-band filter banks, modulated complex lapped transforms, cochlear models, wavelets, etc., can be used for the frequency analysis and synthesis. Because most sounds (e.g., acoustic signals) are complex and comprise more than one frequency, a sub-band analysis on the acoustic signal determines what individual frequencies are present in the acoustic signal during a frame (e.g., a predetermined period of time). According to one embodiment, the frame is 8 ms long.

According to an exemplary embodiment of the present invention, an adaptive intelligent suppression (AIS) generator 312 derives time and frequency varying gains or gain masks used to suppress noise and enhance speech. In order to derive the gain masks, however, specific inputs are needed for the AIS generator 312. These inputs comprise a power spectral density of noise (i.e., noise spectrum), a power spectral density of the primary acoustic signal (i.e., primary spectrum), and an inter-microphone level difference (ILD).

As such, the signals are forwarded to an energy module 304 which computes energy/power estimates during an interval of time for each frequency band (i.e., power estimates) of an acoustic signal. As a result, a primary spectrum (i.e., the power spectral density of the primary acoustic signal) across all frequency bands may be determined by the energy module 304. This primary spectrum may be supplied to an adaptive intelligent suppression (AIS) generator 312 and an ILD module 306 (discussed further herein). Similarly, the energy module 304 determines a secondary spectrum (i.e., the power spectral density of the secondary acoustic signal) across all frequency bands to be supplied to the ILD module 306.

In embodiments utilizing two microphones, power spectrums of both the primary and secondary acoustic signals may be determined. The primary spectrum comprises the power spectrum from the primary acoustic signal (from the primary microphone 106), which contains both speech and noise. In exemplary embodiments, the primary acoustic signal is the signal which will be filtered in the AIS generator 312. Thus, the primary spectrum is forwarded to the AIS generator 312. More details regarding the calculation of power estimates and power spectrums can be found in co-pending U.S. patent application Ser. No. 11/343,524 and co-pending U.S. patent application Ser. No. 11/699,732, which are incorporated by reference.

In two microphone embodiments, the power spectrums are also used by an inter-microphone level difference (ILD) module 306 to determine a time and frequency varying ILD. Because the primary and secondary microphones 106 and 108 may be oriented in a particular way, certain level differences may occur when speech is active and other level differences may occur when noise is active. The ILD is then forwarded to an adaptive classifier 308 and the AIS generator 312. More details regarding the calculation of ILD may be can be found in co-pending U.S. patent application Ser. No. 11/343,524 and co-pending U.S. patent application Ser. No. 11/699,732.

The exemplary adaptive classifier 308 is configured to differentiate noise and distractors (e.g., sources with a negative ILD) from speech in the acoustic signal(s) for each frequency band in each frame. The adaptive classifier 308 is adaptive because features (e.g., speech, noise, and distractors) change and are dependent on acoustic conditions in the environment. For example, an ILD that indicates speech in one situation may indicate noise in another situation. Therefore, the adaptive classifier 308 adjusts classification boundaries based on the ILD.

According to exemplary embodiments, the adaptive classifier 308 differentiates noise and distractors from speech and provides the results to the noise estimate module 310 in order to derive the noise estimate. Initially, the adaptive classifier 308 determines a maximum energy between channels at each frequency. Local ILDs for each frequency are also determined. A global ILD may be calculated by applying the energy to the local ILDs. Based on the newly calculated global ILD, a running average global ILD and/or a running mean and variance (i.e., global cluster) for ILD observations may be updated. Frame types may then be classified based on a position of the global ILD with respect to the global cluster. The frame types may comprise source, background, and distractors.

Once the frame types are determined, the adaptive classifier 308 may update the global average running mean and variance (i.e., cluster) for the source, background, and distractors. In one example, if the frame is classified as source, background, or distractor, the corresponding global cluster is considered active and is moved toward the global ILD. The global source, background, and distractor global clusters that do not match the frame type are considered inactive. Source and distractor global clusters that remain inactive for a predetermined period of time may move toward the background global cluster. If the background global cluster remains inactive for a predetermined period of time, the background global cluster moves to the global average.

Once the frame types are determined, the adaptive classifier 308 may also update the local average running mean and variance (i.e., cluster) for the source, background, and distractors. The process of updating the local active and inactive clusters is similar to the process of updating the global active and inactive clusters.

Based on the position of the source and background clusters, points in the energy spectrum are classified as source or noise; this result is passed to the noise estimate module 310.

In an alternative embodiment, an example of an adaptive classifier 308 comprises one that tracks a minimum ILD in each frequency band using a minimum statistics estimator. The classification thresholds may be placed a fixed distance (e.g., 3 dB) above the minimum ILD in each band. Alternatively, the thresholds may be placed a variable distance above the minimum ILD in each band, depending on the recently observed range of ILD values observed in each band. For example, if the observed range of ILDs is beyond 6 dB, a threshold may be place such that it is midway between the minimum and maximum ILDs observed in each band over a certain specified period of time (e.g., 2 seconds).

In exemplary embodiments, the noise estimate is based only on the acoustic signal from the primary microphone 106. The exemplary noise estimate module 310 is a component which can be approximated mathematically by

N(t,ω)=λ_{I}(t,ω)E₁(t,ω)+(1−λ_{I}(t,ω))min[N(t−1,ω),E₁(t,ω)]

according to one embodiment of the present invention. As shown, the noise estimate in this embodiment is based on minimum statistics of a current energy estimate of the primary acoustic signal, E₁(t,ω) and a noise estimate of a previous time frame, N(t−1,ω). As a result, the noise estimation is performed efficiently and with low latency.

λ_{I}(t,ω) in the above equation is derived from the ILD approximated by the ILD module 306, as

$${λ}_{I} ( t , ω ) = \{ \begin{matrix}\approx 0 & If ILD ( t , ω ) < threshold \\ \approx 1 & if ILD ( t , ω ) > threshold\end{matrix}$$

That is, when the primary microphone 106 is smaller than a threshold value (e.g., threshold=0.5) above which speech is expected to be, λ_{I} is small, and thus the noise estimate module 310 follows the noise closely. When ILD starts to rise (e.g., because speech is present within the large ILD region), λ_{I} increases. As a result, the noise estimate module 310 slows down the noise estimation process and the speech energy does not contribute significantly to the final noise estimate. Therefore, exemplary embodiments of the present invention may use a combination of minimum statistics and voice activity detection to determine the noise estimate. A noise spectrum (i.e., noise estimates for all frequency bands of an acoustic signal) is then forwarded to the AIS generator 312.

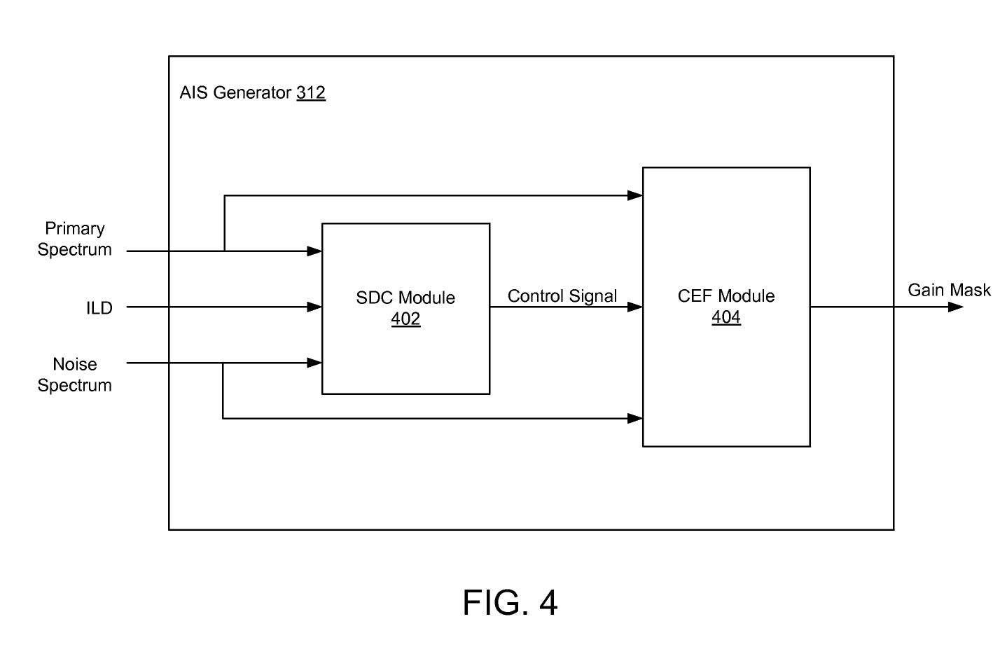

Speech loss distortion (SLD) is based on both the estimate of a speech level and the noise spectrum. The AIS generator 312 receives both the speech and noise of the primary spectrum from the energy module 304 as well as the noise spectrum from the noise estimate module 310. Based on these inputs and an optional ILD from the ILD module 306, a speech spectrum may be inferred; that is the noise estimates of the noise spectrum may be subtracted out from the power estimates of the primary spectrum. Subsequently, the AIS generator 312 may determine gain masks to apply to the primary acoustic signal. The AIS generator 312 will be discussed in more detail in connection with FIG. 4 below.

The SLD is a time varying estimate. In exemplary embodiments, the system may utilize statistics from a predetermined, settable amount of time (e.g., two seconds) of the audio signal. If noise or speech changes over the next few seconds, the system may adjust accordingly.

In exemplary embodiments, the gain mask output from the AIS generator 312, which is time and frequency dependent, will maximize noise suppression while constraining the SLD. Accordingly, each gain mask is applied to an associated frequency band of the primary acoustic signal in a masking module 314.

Next, the masked frequency bands are converted back into time domain from the cochlea domain. The conversion may comprise taking the masked frequency bands and adding together phase shifted signals of the cochlea channels in a frequency synthesis module 316. Once conversion is completed, the synthesized acoustic signal may be output to the user.

In some embodiments, comfort noise generated by a comfort noise generator 318 may be added to the signal prior to output to the user. Comfort noise comprises a uniform, constant noise that is not usually discernable to a listener (e.g., pink noise). This comfort noise may be added to the acoustic signal to enforce a threshold of audibility and to mask low-level non-stationary output noise components. In some embodiments, the comfort noise level may be chosen to be just above a threshold of audibility and may be settable by a user. In exemplary embodiments, the AIS generator 312 may know the level of the comfort noise in order to generate gain masks that will suppress the noise to a level below the comfort noise.

It should be noted that the system architecture of the audio processing engine 204 of FIG. 3 is exemplary. Alternative embodiments may comprise more components, less components, or equivalent components and still be within the scope of embodiments of the present invention. Various modules of the audio processing engine 204 may be combined into a single module. For example, the functionalities of the frequency analysis module 302 and energy module 304 may be combined into a single module. As a further example, the functions of the ILD module 306 may be combined with the functions of the energy module 304 alone, or in combination with the frequency analysis module 302.

Referring now to FIG. 4, the exemplary AIS generator 312 is shown in more detail. The exemplary AIS generator 312 may comprise a speech distortion control (SDC) module 402 and a compute enhancement filter (CEF) module 404. Based on the primary spectrum, ILD, and noise spectrum, gain masks (e.g., time varying gains for each frequency band) may be determined by the AIS generator 312.

The exemplary SDC module 402 is configured to estimate an amount of speech loss distortion (SLD) and to derive associated control signals used to adjust behavior of the CEF module 404. Essentially, the SDC module 402 collects and analyzes statistics for a plurality of different frequency bands. The SLD estimate is a function of the statistics at all the different frequency bands. It should be noted that some frequency bands may be more important than other frequency bands. In one example, certain sounds such as speech are associated with a limited frequency band. In various embodiments, the SDC module 402 may apply weighting factors when analyzing the statistics for a plurality of different frequency bands to better adjust the behavior of the CEF module 404 to produce a more effective gain mask.

In exemplary embodiments, the SDC module 402 may compute an internal estimate of long-term speech levels (SL), based on the primary spectrum and ILD at each point in time, and compare the internal estimate with the noise spectrum estimate to estimate an amount of possible signal loss distortion. According to one embodiment, a current SL may be determined by first updating a decay factor. In one example, the decay factor (in dB) starts at 0 when the SL estimate is updated, and increases linearly with time (e.g., 1 dB per second) until the SL estimate is updated again (at which time it is reset to 0). If the ILD is above some threshold, T, and if the primary spectrum is higher than a current SL estimate minus the decay factor, the SL estimate is updated and set to the primary spectrum (in dB units). If these conditions are not met, the SL estimate is held at its previously estimated value. In some embodiments, the SL estimate may be limited to a lower and upper bound where the speech level is expected to normally reside.

Once the SL estimate is determined, the SLD estimate may be calculated. Initially, the noise spectrum in a frame may be subtracted (in dB units) from the SL estimate, and the M^{th} lowest value of the result calculated. The result is then placed into a circular buffer where the oldest value in the buffer is discarded. The N^{th} lowest value of the SLD over a predetermined time in the buffer is then determined. The result is then used to set the SDC module 402 output under constraints on how quickly the output can change (e.g., slew rate). A resulting output, x, may be transformed to a power domain according to λ=10^{X/10}. The result λ (i.e., the control signal) is then used by the CEF module 404.

The exemplary CEF module 404 generates the gain masks based on the speech spectrum and the noise spectrum, which abide by constraints. These constraints may be driven by the SDC output (i.e., control signals from the SDC module 402) and knowledge of a noise floor and extent to which components of the audio output will be audible. As a result, the gain mask attempts to minimize noise audibility with a maximum SLD constraint and a minimum background noise continuity constraint.

In exemplary embodiments, computation of the gain mask is based on a Wiener filter approach. The standard Wiener filter equation is

$$G ( f ) = \frac{Ps ( f )}{Ps ( f ) + Pn ( f )} ,$$

where Pₛ is a speech signal spectrum, Pₙ is the noise spectrum (provided by the noise estimate module 310), and f is the frequency. In exemplary embodiments, Pₛ may be derived by subtracting Pₙ from the primary spectrum. In some embodiments, the result may be temporally smoothed using a low pass filter.

A modified version of the Wiener filter (i.e., the enhancement filter) that reduces the signal loss distortion is represented by

$$G ( f ) = \frac{Ps ( f )}{Ps ( f ) + γ \cdot Pn ( f )} ,$$

where γ is between zero and one. The lower γ is, the more the signal loss distortion is reduced. In exemplary embodiments, the signal loss distortion may only need to be reduced in situations where the standard Wiener filter will cause the signal loss distortion to be high. Thus, γ is adaptive. This factor, γ, may be obtained by mapping λ, the output of the SDC module 402, onto an interval between zero and one. This might be accomplished using an equation such as γ=min(1, λ/λ₀). In this case, λ₀ is a parameter that corresponds to the minimum allowable SLD.

The modified enhancement filter can increase perceptibility of noise modulation, where the output noise is perceived to increase when speech is active. As a result, it may be necessary to place a limit on the output noise level when speech is not active. This may be accomplished by placing a lower limit on the gain mask, Glb. In exemplary embodiments, Glb may be dependent on λ. As a result, the filter equation may be represented as

$$G ( f ) = max ( Glb ( λ ) , \frac{Ps ( f )}{Ps ( f ) + γ \cdot Pn ( f )} ) ,$$

where Glb generally increases as λ decreases. This may be achieved through the equation Glb=min(1, \sqrt{λ₁/λ}). In this case, λ₁ is a parameter that controls an amount of noise continuity for a given value of λ. The higher λ₁, the more continuity. As such, the CEF module 404 essentially replaces the Wiener filter of prior embodiments.

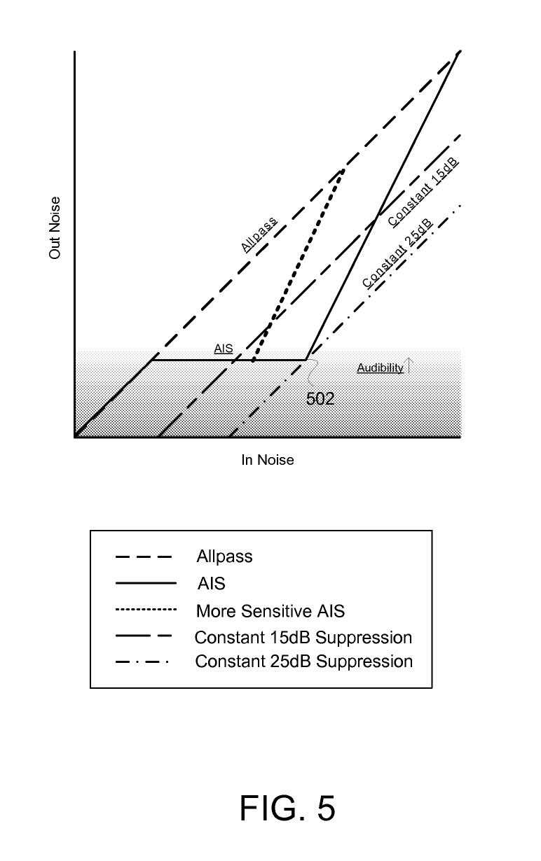

Referring now to FIG. 5, a diagram illustrating adaptive intelligent (noise) suppression (AIS) compared to constant noise suppression systems is illustrated. As shown, embodiments of the present invention attempt to keep the output noise near a threshold of audibility. Thus, if the noise is below a level of audibility, no noise suppression may be applied by embodiments of the present invention. However, when the noise level becomes audible, embodiments of the present invention will attempt to keep the output noise to a level just under the level of audibility.

Embodiments of the present invention may at different times suppress more and at other times suppress less then a constant suppression system. Additionally, embodiments may adjust to be more or less sensitive to speech distortion. For example, an AIS setting that is more sensitive to speech distortion and thus provide conservative suppression is shown in FIG. 5 (i.e., more sensitive AIS). However, the perception is essentially identical when the output noise is kept below the threshold of audibility.

In exemplary embodiments, the output noise is kept constant until the noise level becomes too high. Once the noise level rises to a level that is too high, the gain masks are adjusted by the AIS generator 312 to reduce the amount of suppression in order to avoid SLD. In exemplary embodiments, the present invention may be adjusted to be more or less sensitive to SLD by a user.

As discussed above, the threshold of audibility may be enforced or controlled by the addition of comfort noise. The presence of comfort noise may ensure that output noise components at a level below that of the comfort noise level are not perceivable to a listener.

Generally, speech distortion may occur for SNRs lower than 15 dB. In exemplary embodiments, the amount of noise suppression below 15 dB may be reduced. The maximum amount of noise suppression will occur at a knee 502 on the in noise/out noise curve. However, the actual SNR at which the knee 502 occurs is signal dependent, since embodiments of the present invention utilizes an estimate of signal loss distortion (SLD) and not SNR. For a given SNR for different types of audio sources, different amounts of speech degradation may occur. For example, narrowband and non-stationary noise signals may cause less signal loss distortion than broadband and stationary noise. The knee 502 may then occur at a lower SNR for the narrowband and non-stationary noise signals. For example, if the knee 502 occurs at 5 dB SNR, for a pink noise source, it may occur at 0 dB for a noise source comprising speech.

In some embodiments, noise gating may occur at very high noise levels. If there is a pause in speech, embodiments of the present invention may be providing a lot of noise suppression. When the speech comes on, the system may quickly back off on the noise suppression, but some noise can be heard as the speech comes on. As a result, noise suppression needs to be backed off a certain amount so that some continuity exists which the system can use to group noise components together. So rather than having noise coming on when the speech becomes present, some background noise may be preserved (i.e., reduce noise suppression to an amount necessary to reduce the noise gating effect). Then, it becomes less of an annoying effect and not really noticeable when speech is present.

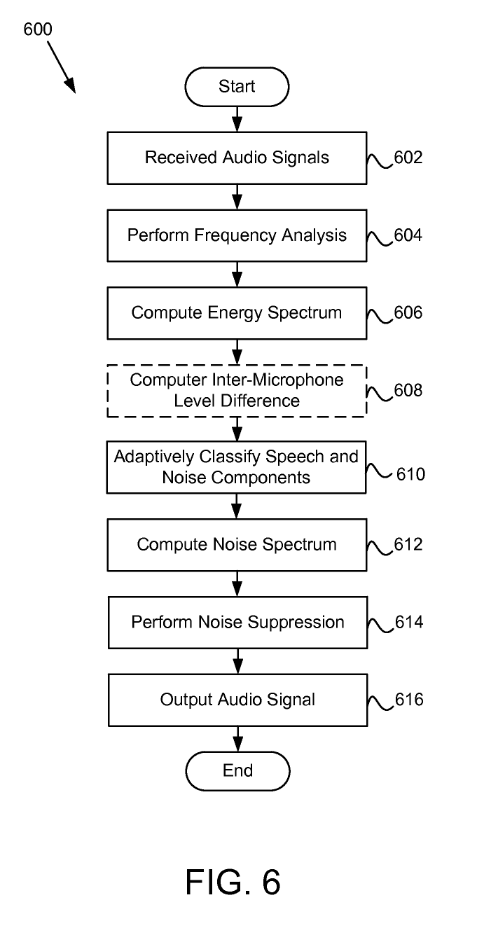

Referring now to FIG. 6, an exemplary flowchart 600 of an exemplary method for noise suppression utilizing an adaptive intelligent suppression (AIS) system is shown. In step 602, audio signals are received by a primary microphone 106 and an optional secondary microphone 108. In exemplary embodiments, the acoustic signals are converted to digital format for processing.

Frequency analysis is then performed on the acoustic signals by the frequency analysis module 302 in step 604. According to one embodiment, the frequency analysis module 302 utilizes a filter bank to determine individual frequency bands present in the acoustic signal(s).

In step 606, energy spectrums for acoustic signals received at both the primary and secondary microphones 106 and 108 are computed. In one embodiment, the energy estimate of each frequency band is determined by the energy module 304. In exemplary embodiments, the exemplary energy module 304 utilizes a present acoustic signal and a previously calculated energy estimate to determine the present energy estimate.

Once the energy estimates are calculated, inter-microphone level differences (ILD) are computed in optional step 608. In one embodiment, the ILD is calculated based on the energy estimates (i.e., the energy spectrum) of both the primary and secondary acoustic signals. In exemplary embodiments, the ILD is computed by the ILD module 306.

Speech and noise components are adaptively classified in step 610. In exemplary embodiments, the adaptive classifier 308 analyzes the received energy estimates and, if available, the ILD to distinguish speech from noise in an acoustic signal.

Subsequently, the noise spectrum is determined in step 612. According to embodiments of the present invention, the noise estimates for each frequency band is based on the acoustic signal received at the primary microphone 106. The noise estimate may be based on the present energy estimate for the frequency band of the acoustic signal from the primary microphone 106 and a previously computed noise estimate. In determining the noise estimate, the noise estimation is frozen or slowed down when the ILD increases, according to exemplary embodiments of the present invention.

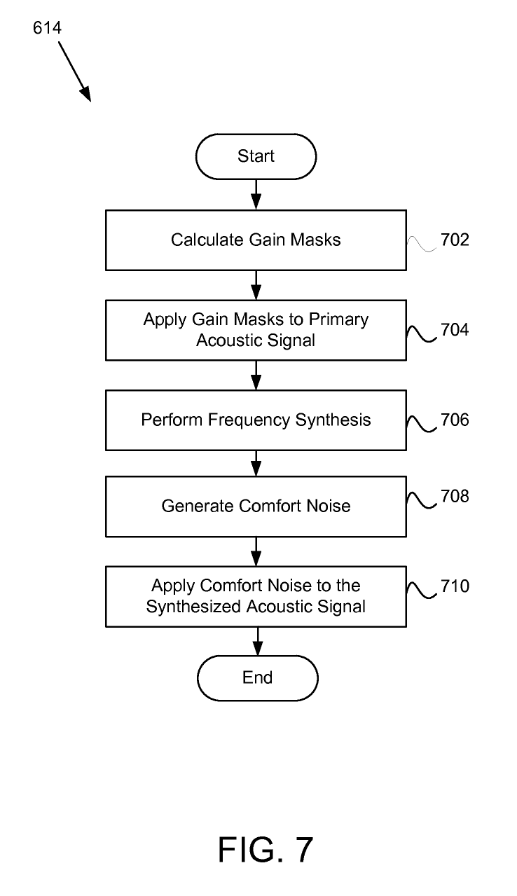

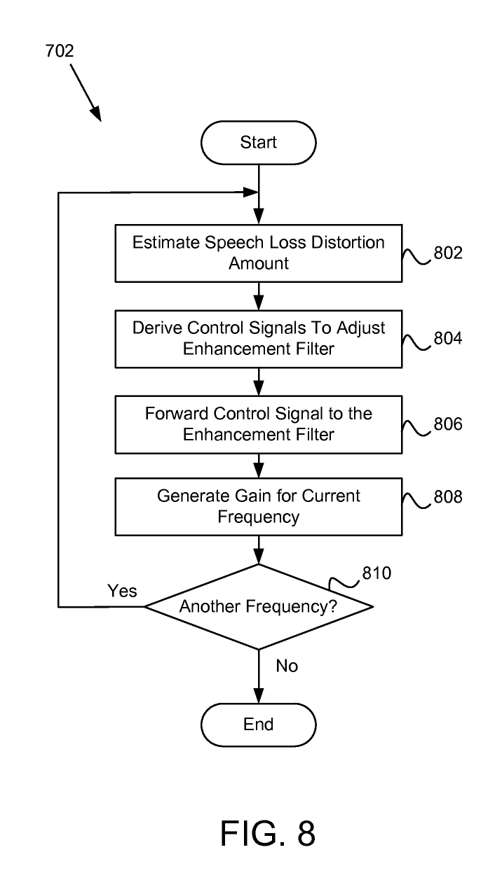

In step 614, noise suppression is performed. The noise suppression process will be discussed in more details in connection with FIG. 7 and FIG. 8. The noise suppressed acoustic signal may then be output to the user in step 616. In some embodiments, the digital acoustic signal is converted to an analog signal for output. The output may be via a speaker, earpieces, or other similar devices, for example.

Referring now to FIG. 7, a flowchart of an exemplary method for performing noise suppression (step 614) is shown. In step 702, gain masks are calculated by the AIS generator 312. The calculated gain masks may be based on the primary power spectrum, the noise spectrum, and the ILD. An exemplary process for generating the gain masks will be provided in connection with FIG. 8 below.

Once the gain masks are calculated, the gain masks may be applied to the primary acoustic signal in step 704. In exemplary embodiments, the masking module 314 applies the gain masks.

In step 706, the masked frequency bands of the primary acoustic signal are converted back to the time domain. Exemplary conversion techniques apply an inverse frequency of the cochlea channel to the masked frequency bands in order to synthesize the masked frequency bands.

In some embodiments, a comfort noise may be generated in step 708 by the comfort noise generator 318. The comfort noise may be set at a level that is slightly above audibility. The comfort noise may then be applied to the synthesized acoustic signal in step 710. In various embodiments, the comfort noise is applied via an adder.

Referring now to FIG. 8, a flowchart of an exemplary method for calculating gain masks (step 702) is shown. In exemplary embodiments, a gain mask is calculated for each frequency band of the primary acoustic signal.

In step 802, a speech loss distortion (SLD) amount is estimated. In exemplary embodiments, the SDC module 402 determines the SLD amount by first computing an internal estimate of long-term speech levels (SL), which may be based on the primary spectrum and the ILD. Once the SL estimate is determined, the SLD estimate may be calculated. In step 804, control signals are then derived based on the SLD amount. These control signals are then forwarded to the enhancement filter in step 806.

In step 808, a gain mask for a current frequency band is generated based on a short-term signal and the noise estimate for the frequency band by the enhancement filter. In exemplary embodiments, the enhancement filter comprises a CEF module 404. If another frequency band of the acoustic signal requires the calculation of a gain mask in step 810, then the process is repeated until the entire frequency spectrum is accommodated.

While embodiments the present invention are described utilizing an ILD, alternative embodiments need not be in an ILD environment. Normal speech levels are predictable, and speech may vary within 10 dB higher or lower. As such, the system may have knowledge of this range, and can assume that the speech is at the lowest level of the allowable range. In this case, ILD is set to equal 1. Advantageously, the use of ILD allows the system to have a more accurate estimate of speech levels.

The above-described modules can be comprises of instructions that are stored on storage media. The instructions can be retrieved and executed by the processor 202. Some examples of instructions include software, program code, and firmware. Some examples of storage media comprise memory devices and integrated circuits. The instructions are operational when executed by the processor 202 to direct the processor 202 to operate in accordance with embodiments of the present invention. Those skilled in the art are familiar with instructions, processor(s), and storage media.

The present invention is described above with reference to exemplary embodiments. It will be apparent to those skilled in the art that various modifications may be made and other embodiments can be used without departing from the broader scope of the present invention. For example, embodiments of the present invention may be applied to any system (e.g., non speech enhancement system) as long as a noise power spectrum estimate is available. Therefore, these and other variations upon the exemplary embodiments are intended to be covered by the present invention.

1. A method for adaptively controlling a sub-band noise suppressor, comprising:
determining a speech loss distortion estimate based on a primary acoustic signal, the primary acoustic signal representing at least one captured sound, the speech loss distortion estimate being a function of a signal-to-noise ratio estimate of the primary acoustic signal;
determining a control parameter and an adaptive modifier using the speech loss distortion estimate; and
controlling the sub-band noise suppressor using the control parameter and the adaptive modifier.

2. The method of claim 1 wherein determining the speech loss distortion estimate comprises subtracting a calculated noise spectrum from a power spectrum of the primary acoustic signal.

3. The method of claim 2 further comprising calculating the power spectrum of the primary acoustic signal.

4. The method of claim 1 further comprising classifying noise and speech in the primary acoustic signal.

5. The method of claim 1 further comprising:
determining an inter-level difference between the primary acoustic signal and a another acoustic signal, and
determining the control parameter and the adaptive modifier using the inter-level difference and speech loss distortion estimate.

6. The method of claim 1 wherein the speech loss distortion estimate is a function of a weighted signal-to-noise ratio estimate of the primary acoustic signal.

7. The method of claim 1 wherein the adaptive modifier is a factor.

8. The method of claim 1 wherein the sub-band noise suppressor is an enhancement filter having a filter equation, the filter equation being a function of the control parameter and the adaptive modifier.

9. The method of claim 1 further comprising:
suppressing noise using the control parameter and the adaptive modifier to produce a noise suppressed signal;
generating and applying a comfort noise to the noise suppressed signal to produce an output signal.

10. The method of claim 9 wherein determining the speech loss distortion estimate comprises subtracting a calculated noise spectrum from a power spectrum of the primary acoustic signal.

11. The method of claim 9 wherein generating the comfort noise comprises setting the comfort noise to a level that is just above a level of audibility.

12. The method of claim 9 further comprising:
determining an inter-level difference between the primary acoustic signal and a another acoustic signal, and
determining the control parameter and the adaptive modifier using the inter-level difference and speech loss distortion estimate.

13. A system for adaptively suppressing controlling a sub-band noise suppressor, comprising:
a memory, the memory storing a program and the program being executable by at least one hardware processor to perform a method for adaptively controlling a sub-band noise suppressor, the method comprising:
determining a speech loss distortion estimate based on a primary acoustic signal, the primary acoustic signal representing at least one captured sound, the speech loss distortion estimate being a function of a signal-to-noise ratio estimate of the primary acoustic signal,
determining a control parameter and an adaptive modifier using the speech loss distortion estimate, and
controlling the sub-band noise suppressor using the control parameter and the adaptive modifier.

14. The system of claim 13 wherein determining the speech loss distortion estimate comprises subtracting a calculated noise spectrum from a power spectrum of the primary acoustic signal.

15. The system of claim 13 wherein the method further comprises:
determining an inter-level difference between the primary acoustic signal and another acoustic signal, and
determining the control parameter and the adaptive modifier using the inter-level difference and speech loss distortion estimate.

16. The system of claim 13 wherein the method further comprises generating a primary spectrum of the primary acoustic signal.

17. The system of claim 15 wherein the method further comprises calculating a power spectrum of the primary acoustic signal.

18. A non-transitory computer readable storage medium having embodied thereon a program, the program being executable by a processor to perform a method for controlling a sub-band noise suppressor, the method comprising:
determining a speech loss distortion estimate based on a primary acoustic signal, the primary acoustic signal representing at least one captured sound, the speech loss distortion estimate being a function of a signal-to-noise ratio estimate of the primary acoustic signal;
determining a control parameter and an adaptive modifier using the speech loss distortion estimate; and
controlling the sub-band noise suppressor using the control parameter and the adaptive modifier.

19. The non-transitory computer readable storage medium of claim 18, the method further comprising:
determining an inter-level difference between the primary acoustic signal and another acoustic signal, and
determining the control parameter and the adaptive modifier using the inter-level difference and speech loss distortion estimate.
